(19) United States
(12) Patent Application Publication
(10) Pub. No.: US 2014/0179423 A1
(43) Pub. Date: Jun. 26, 2014

(54) Video Game Display System and Related Method of Using a Portable Computing Device to Control Game Play in Video Games Displayed on a Wireless Display

(71) Applicant: ARCSOFT (HANGZHOU) MULTIMEDIA TECHNOLOGY CO., LTD., Hangzhou City (CN)

(72) Inventors: Hui Deng, Hangzhou City (CN); Yanlong Sun, Hangzhou City (CN); Wei Wan, Hangzhou City (CN)

(73) Assignee: ARCSOFT (HANGZHOU) MULTIMEDIA TECHNOLOGY CO., LTD., Hangzhou City (CN)

(21) Appl. No.: 13/726,550

(22) Filed: Dec. 25, 2012

(51) Int. Cl. A63F 13/00

(52) U.S. Cl. CPC A63F 13/00
USPC 463/31

(57) ABSTRACT

A method of using a portable computing device to control game play in video games displayed on a wireless display includes executing a video game control application and selecting a video game to be run on the portable computing device, displaying a control interface of the video game control application on a screen of the portable computing device, and receiving input signals from a user of the portable computing device via the control interface of the video game control application for controlling game play in the selected video game. The method also includes rendering, encoding, and multiplexing the video data corresponding to the selected video game as the selected video game is played according to the received input signals. The video data is wirelessly transmitted from the portable computing device to the wireless display where the video data is displayed as the video game is played.

### BACKGROUND OF THE INVENTION

1. Field of the Invention

The invention relates to a wireless video game display system, and more particularly to a video game display system for using a portable computing device to control game play in video games displayed on a wireless display.

2. Description of the Prior Art

Wi-Fi Displays are wireless displays that allow users to transmit video content from a source device to the Wi-Fi Display for displaying the video content on the Wi-Fi Display. In this way a user can watch the video content on a Wi-Fi Display that is more suitable for the user's purpose than a display of the source device. For instance, suppose the user wishes to broadcast the video content being shown on the screen of a mobile phone to a large screen television so that multiple people can comfortably watch the video content on the television together. In this example, the mobile phone is the source device, the television is the Wi-Fi Display (assuming the television supports Wi-Fi Display specifications), and the source device transmits video content to the Wi-Fi Display for playback on the Wi-Fi Display. One example of video content that can be shared is a video game being played on the source device 12.

Please refer to FIG. 1. FIG. 1 is a block diagram of a video game display system 10 according to the prior art. The video game display system 10 contains a source device 12 and a Wi-Fi Display 14. A video game is played on the source device 12 and the video content shown on the screen of the source device 12 is transmitted to the Wi-Fi Display 14 using Real-time Transport Protocol (RTP) streaming.

Prior art methods of sharing video content from the source device 12 to the Wi-Fi Display 14 require the Wi-Fi Display 14 to act as a mirror of what is shown on a screen of the source device 12. Because of this, numerous steps must be performed for mirroring the video content shown on the screen of the source device 12 to the Wi-Fi Display 14. Furthermore, when playing a video game on the source device 12, at least a portion of the screen of the source device 12 may be needed for showing controls that the user needs to operate in order to play the video game. This leads to the situation in which part of the screen of the source device 12 is used for displaying control buttons while the other part of the screen is used for displaying the actual game being played. When the screen of the source device 12 is mirrored to the Wi-Fi Display 14, both the control buttons and the video game will also be shown on the Wi-Fi Display 14, which is unnecessary.

Please refer to FIG. 2. FIG. 2 is a flowchart describing the prior art method of mirroring the screen of the source device 12 on the Wi-Fi Display 14 for sharing a video game being played on the source device 12 with the Wi-Fi Display 14. Steps in the flowchart will be explained as follows.

Step 20: Show both the video game being played and control buttons used for controlling game play on the screen of the source device 12.

Step 22: A screen capture process is performed for capturing the video data shown on the screen of the source device 12.

Step 24: The captured video data is then encoded into the H.264 video format, which is necessary for compatibility with the Wi-Fi Display 14.

Step 26: The encoded video data is multiplexed into a Moving Picture Experts Group (MPEG) transport stream format, which is also necessary for compatibility with the Wi-Fi Display 14.

Step 28: The multiplexed video data is wirelessly transmitted to the Wi-Fi Display 14 using RTP streaming.

Step 30: The video data shown on the screen of the source device 12 is mirrored on the Wi-Fi Display 14 for allowing the user to see both the video game being played and the control buttons on the Wi-Fi Display 14.

Unfortunately, as seen in the flowchart of FIG. 2, there are numerous steps that must be performed before the video content shown on the screen of the source device 12 can be mirrored on the Wi-Fi Display 14 . One major drawback is the video content shown on the screen of the source device 12 is captured before it is transmitted to the Wi-Fi Display 14. Consequently, users are limited to using the Wi-Fi Display 14 as a mirror of the screen of the source device 12, and cannot show different data on the Wi-Fi Display 14 than what is being shown on the screen of the source device 12. If control buttons are shown on the screen of the source device 12 for allowing the user to better control game play, then these same control buttons will also be mirrored on the Wi-Fi Display 14 . Moreover, the screen capture step needed for outputting video content from the source device 12 to the Wi-Fi Display 14 may lead to quality loss and degradation in video signals. Another problem with the prior art method is the screen of the source device 12 is too small to effectively show both the control buttons and the video game being played. Moreover, power is spent by using the screen of the source device 12 to display the video game being played, which may diminish the charge stored in the battery of the source device 12 more quickly than if the video game was not displayed on the screen of the source device 12. Consequently, there exists a need for an improved method of outputting video content to a Wi-Fi Display.

### SUMMARY OF THE INVENTION

It is therefore one of the primary objectives of the claimed invention to provide an improved method and video game display system for outputting video content from a source device to a wireless display such as a Wi-Fi Display.

According to an exemplary embodiment of the claimed invention, a method of using a portable computing device to control game play in video games displayed on a wireless display is disclosed. The method includes executing a video game control application and selecting a video game to be run on the portable computing device, displaying a control interface of the video game control application on a screen of the portable computing device, receiving input signals from a user of the portable computing device via the control interface of the video game control application for controlling game play in the selected video game, rendering video data corresponding to the selected video game as the selected video game is played according to the received input signals, and encoding the rendered video data to convert the rendered video data to conform to the H.264 video format standard. The method also includes multiplexing the encoded video data to convert the encoded video data such that the multiplexed video data conforms to the MPEG transport stream video format standard in addition to the H.264 video format standard, wherein the multiplexed video data is created without capturing contents of the screen of the portable computing device, wirelessly transmitting the multiplexed video data from the portable computing device to the wireless display, and displaying the multiplexed video data on the wireless display while controlling game play of the selected video game using the control interface of the video game control application executed on the portable computing device.

According to another exemplary embodiment of the claimed invention, a video game display system includes a portable computing device adapted for executing a video game control application and selecting a video game to be run on the portable computing device. The portable computing device includes a user interface displaying a control interface of the video game control application on a screen of the portable computing device and receiving input signals from a user of the portable computing device via the control interface of the video game control application for controlling game play in the selected video game, and a processor controlling operation of the portable computing device, rendering video data corresponding to the selected video game as the selected video game is played according to the received input signals, encoding the rendered video data to convert the rendered video data to conform to the H.264 video format standard, and multiplexing the encoded video data to convert the encoded video data such that the multiplexed video data conforms to the MPEG transport stream video format standard in addition to the H.264 video format standard, wherein the multiplexed video data is created without capturing contents of the screen of the portable computing device. The portable computing device also includes a wireless transceiver for wirelessly transmitting the multiplexed video data from the portable computing device to a wireless display. The wireless display receives the multiplexed video data from the portable computing device and displaying the multiplexed video data on the wireless display. Game play of the selected video game is controlled using the control interface of the video game control application executed on the portable computing device while the multiplexed video data is displayed on the wireless display.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a video game display system according to the prior art.

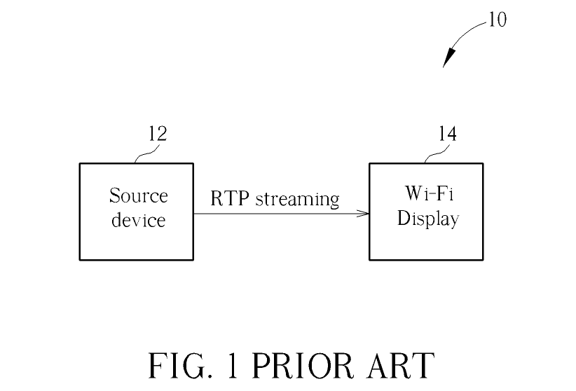

FIG. 2 is a flowchart describing the prior art method of mirroring the screen of a source device on a Wi-Fi Display for sharing a video game being played on the source device with the Wi-Fi Display.

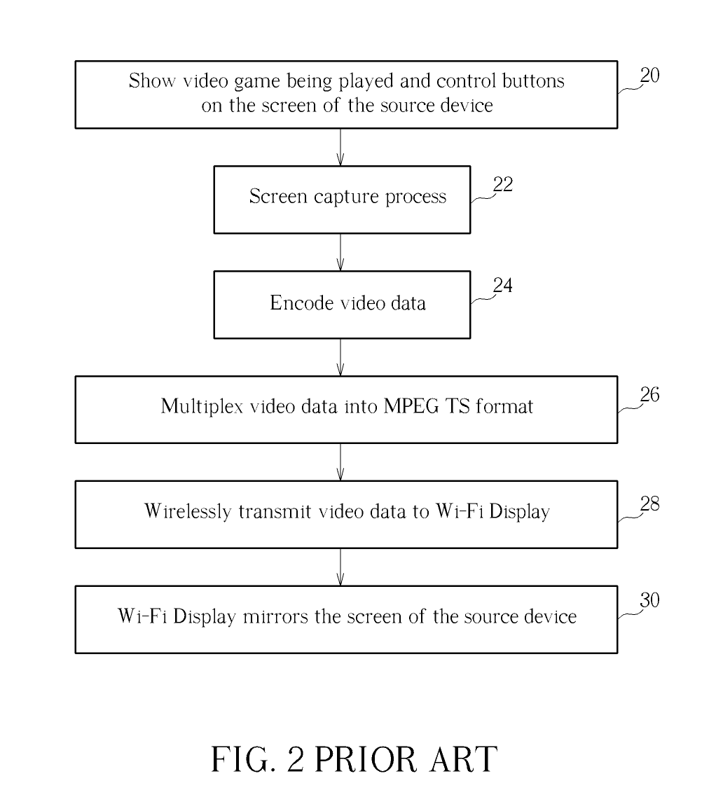

FIG. 3 is a block diagram of a video game display system according to the present invention.

FIG. 4 is a functional block diagram of the portable computing device.

FIG. 5 is a flowchart describing the process of using the portable computing device to control game play in video games displayed on the Wi-Fi Display according to the present invention.

### DETAILED DESCRIPTION

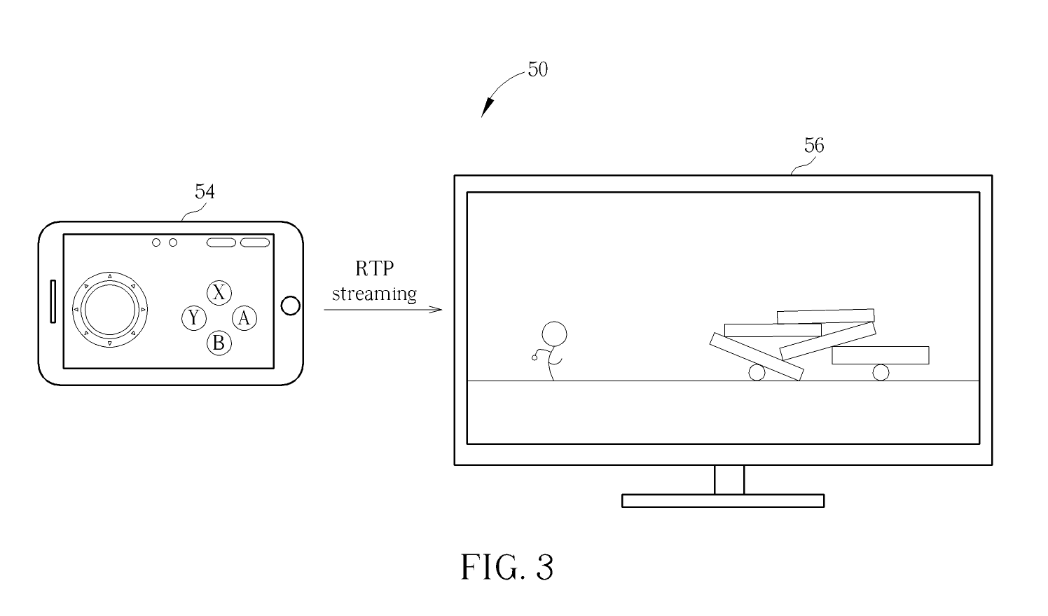

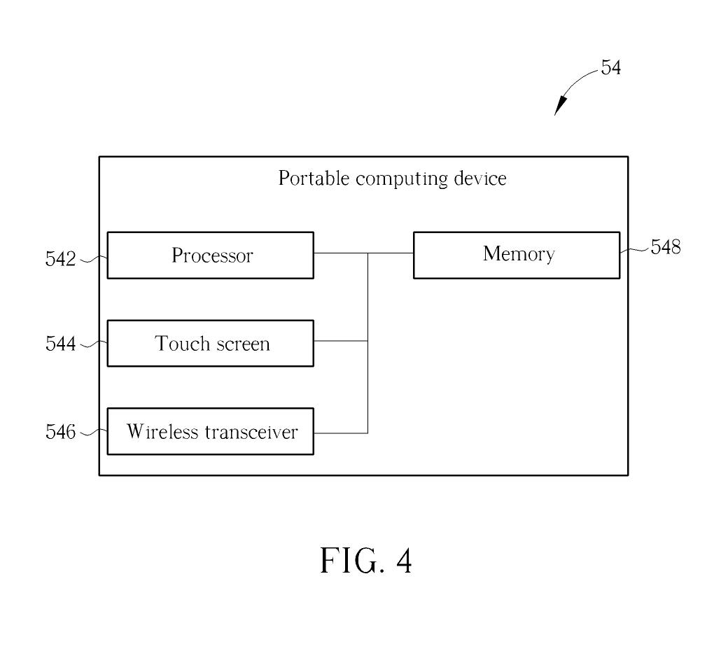

Please refer to FIG. 3 and FIG. 4. FIG. 3 is a block diagram of a video game display system 50 according to the present invention. The video game display system 50 contains a portable computing device 54 and a Wi-Fi Display 56. FIG. 4 is a functional block diagram of the portable computing device 54. The portable computing device 54 contains a processor 542 for controlling operation of the portable computing device 54 and a touch screen 544 for outputting video content and for receiving touch control signals from a user of the portable computing device 54. The portable computing device 54 also contains a wireless transceiver 546 for wirelessly communicating with the Wi-Fi Display 56 as well as a memory 548 for storing programs and data.

In the present invention, the portable computing device 54 uses the Wi-Fi Display 56 as a virtual display of the portable computing device 54. That is, what is shown on the Wi-Fi Display 56 does not need to mirror what is shown on the touch screen 544 of the portable computing device 54. Instead, the portable computing device 54 can use the Wi-Fi Display 56 as a second screen. The first screen, which is the touch screen 544 of the portable computing device 54, can serve as a control interface for a video game control application executed on the portable computing device 54. As shown in FIG. 3, the control interface includes a virtual directional pad and virtual control buttons that the user can push to provide input signals to the portable computing device 54. A virtual joystick can also be used instead of or in addition to the virtual directional pad. In addition, the video game control application may receive input signals from a gyroscope, an accelerometer, a rotation vector sensor, or any combination thereof.

When the user of the portable computing device 54 wishes to play a video game on the portable computing device 54 and output the video content of the video game to the Wi-Fi Display 56, the user can execute a video game control application on the portable computing device 54 and select a video game to be run. Then a control interface of the video game control application is shown on the touch screen 544, as depicted in FIG. 3. The user can then use the touch screen 544 for issuing input signals to control game play while watching the corresponding video content of the video game on the Wi-Fi Display 56.

Thus, the second screen, which is the Wi-Fi Display 56, is used for displaying the video content of the video game being played. By eliminating the need for the Wi-Fi Display 56 to mirror what is shown on the touch screen 544 of the portable computing device 54, the present invention provides a simpler and more flexible way to share enjoy video games on the Wi-Fi Display 56 while using the portable computing device 54 as a controller for the video game. The Wi-Fi Display 56 may be a television, a set-top box, or any other device that supports the Wi-Fi Display specifications.

The video content transmitted from the portable computing device 54 to the Wi-Fi Display 56 needs to be in the proper format before it can be played on the Wi-Fi Display 56. The Wi-Fi Display 56 can play video content that is in the H.264 video format and that has been encapsulated into the MPEG transport stream format. Once the video content is in the proper format the video content is wirelessly transmitted from the portable computing device 54 to the Wi-Fi Display 56 using RTP streaming. The audio format of audio contained in the video data may be an audio format standard such as AC-3, Advanced Audio Coding (AAC), or Linear pulse-code modulation (LPCM).

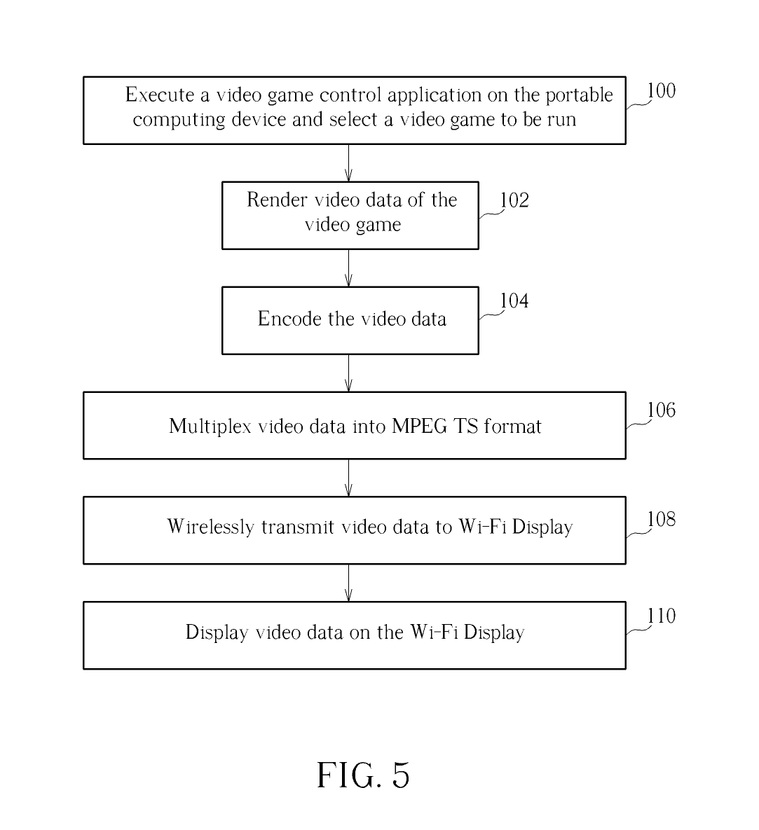

Please refer to FIG. 5. FIG. 5 is a flowchart describing the process of using the portable computing device 54 to control game play in video games displayed on the Wi-Fi Display 56 according to the present invention. Steps in the flowchart will be explained as follows.

Step 100: Execute a video game control application on the portable computing device 54 and select a video game to be run. The video game control application shows a control interface on the touch screen 544, and the user can use the touch screen 544 for issuing input signals to control game play.

Step 102: The portable computing device 54 renders video data corresponding to the selected video game while the selected video game is played according to the received input signals issued by the user.

Step 104: Encode the rendered video data to convert the rendered video data to conform to the H.264 video format standard.

Step 106: Multiplex the encoded video data to convert the encoded video data into the Moving Picture Experts Group (MPEG) transport stream format.

Step 108: Since the multiplexed video data is now in the proper format for being played on the Wi-Fi Display 56, the portable computing device 54 can wirelessly transmit the multiplexed video data to the Wi-Fi Display 56 using RTP streaming.

Step 110: The multiplexed video data is displayed on the Wi-Fi Display 56 while the user controls game play of the selected video game using the control interface of the video game control application executed on the portable computing device 54.

The portable computing device 54 can be a tablet computer, a mobile phone, or other such portable devices that are capable of executing a video game control application, playing a video game, and having have Wi-Fi capability.

Differing from the prior art method of playing video games while sharing video data on a Wi-Fi Display, the present invention avoids the need for the Wi-Fi Display 56 to mirror the touch screen 544 of the portable computing device 54. Consequently, it is not necessary to perform the screen capture process for sending a copy of what is shown on the touch screen 544 of the portable computing device 54 to the Wi-Fi Display 56. Thus, there is less burden placed on the portable computing device 54 when outputting video to the Wi-Fi Display 56 using the present invention method than there is in the prior art method. Since the Wi-Fi Display 56 does not mirror the touch screen 544, the touch screen 544 can be used for showing the control interface of the video game control application executed on the portable computing device 54 while the Wi-Fi Display 56 is used for showing the corresponding video content of the video game as the user plays the video game. The control interface can therefore be shown in a larger size on the touch screen 544 and the video game can be shown on the entire viewing area of the Wi-Fi Display 56.

Other advantages provided by the present invention method include improved video quality enjoyed in the present invention by sending the rendered video data from the portable computing device 54 directly to the Wi-Fi Display 56 without the need for a screen capture step to be performed first. Furthermore, by avoiding using the touch screen 544 to display the video game being played, the portable computing device 54 saves power, and can efficiently display the relatively static control interface of the video game control application instead.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of using a portable computing device to control game play in video games displayed on a wireless display, the method comprising:
executing a video game control application and selecting a video game to be run on the portable computing device;
displaying a control interface of the video game control application on a screen of the portable computing device;
receiving input signals from a user of the portable computing device via the control interface of the video game control application for controlling game play in the selected video game;
rendering video data corresponding to the selected video game as the selected video game is played according to the received input signals;
encoding the rendered video data to convert the rendered video data to conform to the H.264 video format standard;
multiplexing the encoded video data to convert the encoded video data such that the multiplexed video data conforms to the MPEG transport stream video format standard in addition to the H.264 video format standard, wherein the multiplexed video data is created without capturing contents of the screen of the portable computing device;
wirelessly transmitting the multiplexed video data from the portable computing device to the wireless display; and
displaying the multiplexed video data on the wireless display while controlling game play of the selected video game using the control interface of the video game control application executed on the portable computing device.

2. The method of claim 1, wherein the wireless display is a Wi-Fi Display.

3. The method of claim 2, wherein the Wi-Fi Display is a television.

4. The method of claim 2, wherein the Wi-Fi Display is a set-top box.

5. The method of claim 1, wherein wirelessly transmitting the video data from the portable computing device to the wireless display is performed using Real-time Transport Protocol (RTP) streaming.

6. The method of claim 1, wherein the video data wirelessly transmitted from the portable computing device to the wireless display has an audio format conforming to a standard selected from AC-3, Advanced Audio Coding (AAC), or Linear pulse-code modulation (LPCM) audio format standards.

7. The method of claim 1, wherein the wireless display serves as a virtual display of the portable computing device and does not mirror the screen of the portable computing device.

8. The method of claim 1, wherein the portable computing device is a mobile phone or a tablet computer.

9. The method of claim 1, wherein the control interface of the video game control application includes a virtual joystick or a virtual directional pad, and includes virtual control buttons.

10. The method of claim 1, wherein the video game control application receives input signals from one or more of a gyroscope, an accelerometer, or a rotation vector sensor of the portable computing device.

11. A video game display system, comprising:
a portable computing device adapted for executing a video game control application and selecting a video game to be run on the portable computing device, the portable computing device comprising:
a user interface displaying a control interface of the video game control application on a screen of the portable computing device and receiving input signals from a user of the portable computing device via the control interface of the video game control application for controlling game play in the selected video game;
a processor controlling operation of the portable computing device, rendering video data corresponding to the selected video game as the selected video game is played according to the received input signals, encoding the rendered video data to convert the rendered video data to conform to the H.264 video format standard, and multiplexing the encoded video data to convert the encoded video data such that the multiplexed video data conforms to the MPEG transport stream video format standard in addition to the H.264 video format standard, wherein the multiplexed video data is created without capturing contents of the screen of the portable computing device; and
a wireless transceiver for wirelessly transmitting the multiplexed video data from the portable computing device to a wireless display; and
the wireless display receiving the multiplexed video data from the portable computing device and displaying the multiplexed video data on the wireless display,
wherein game play of the selected video game is controlled using the control interface of the video game control application executed on the portable computing device while the multiplexed video data is displayed on the wireless display.

12. The video game display system of claim 11, wherein the wireless display is a Wi-Fi Display.

13. The video game display system of claim 12, wherein the Wi-Fi Display is a television.

14. The video game display system of claim 12, wherein the Wi-Fi Display is a set-top box.

15. The video game display system of claim 11, wherein wirelessly transmitting the video data from the portable computing device to the wireless display is performed using Real-time Transport Protocol (RTP) streaming.

16. The video game display system of claim 11, wherein the video data wirelessly transmitted from the portable computing device to the wireless display has an audio format conforming to a standard selected from AC-3, Advanced Audio Coding (AAC), or Linear pulse-code modulation (LPCM) audio format standards.

17. The video game display system of claim 11, wherein the wireless display serves as a virtual display of the portable computing device and does not mirror the screen of the portable computing device.

18. The video game display system of claim 11, wherein the portable computing device is a mobile phone or a tablet computer.

19. The video game display system of claim 11, wherein the control interface of the video game control application includes a virtual joystick or a virtual directional pad, and includes virtual control buttons.

20. The video game display system of claim 11, wherein the video game control application receives input signals from one or more of a gyroscope, an accelerometer, or a rotation vector sensor of the portable computing device.
